(19) United States
(12) Patent Application Publication
(10) Pub. No.: US 2007/0183700 A1
(43) Pub. Date: Aug. 9, 2007

(54) Fluid dynamic bearing system

(76) Inventor: Olaf Winterhalter, Epfendorf (DE)

Correspondence Address: NORMAN H. ZIVIN;Cooper & Dunham LLP, 1185 Avenue of the Americas, New York, NY, 10036, US

(21) Appl. No.: 11/701,132

(22) Filed: Feb. 1, 2007

(30) Foreign Application Priority Data
Feb. 6, 2006 (DE) 10 2006 005 602.7

(51) Int. Cl. F16C 32/06

(52) U.S. Cl. 384/114

(57) ABSTRACT

The invention relates to a fluid dynamic bearing system used particularly for a spindle motor having a shaft that is accommodated in a bearing bush and rotatably supported with respect to the bearing bush. According to the invention the bearing bush is made of plastics.

### BACKGROUND OF THE INVENTION

The invention relates to a fluid dynamic bearing system used particularly to rotatably support a spindle motor as employed, for example, to drive hard disk drives.

### PRIOR ART

Spindle motors substantially consist of a stator, a rotor and at least one bearing system arranged between these two parts. The electrically driven rotor is rotatably supported with respect to the stator by means of the bearing system. Fluid dynamic bearings are frequently employed as the bearing system.

DE 202 18 821 U1 reveals a typical fluid dynamic bearing system for spindle motors that comprises a bearing bush and a shaft which is disposed in an axial bore in the bearing bush. The shaft rotates freely in the bearing bush, the two parts together forming a radial bearing whose surfaces are spaced apart from each other by a thin, concentric bearing gap filled with a lubricant.

Axial displacement of the shaft along the rotational axis is prevented by appropriately designed fluid dynamic thrust bearings. These kinds of thrust bearings are frequently formed by the two end faces of a thrust plate arranged at one end of the shaft, each end face being associated with a corresponding end face of the bearing bush and an inner end face of a cover plate. The cover plate forms a counter bearing to the thrust plate and seals the entire bearing system from below.

The components of the bearing system are generally made of steel, aluminum or sintered metals and are connected to each other by pressing, welding or bonding. The material and assembly costs are thus relatively high.

### SUMMARY OF THE INVENTION

It is the object of the invention to provide a fluid dynamic bearing system for use in a spindle motor that can be built and assembled at significantly lower costs.

This object has been achieved according to the invention by the characteristics revealed in claim 1.

Preferred embodiments of the invention and other advantageous characteristics can be derived from the subordinate claims.

The fluid dynamic bearing system according to the invention comprises a shaft that is accommodated in a bearing bush and rotatably supported with respect to the bearing bush. According to the invention, the bearing bush is made entirely of plastics, so that, compared to a conventional bearing bush made of steel, it can be manufactured at considerably less cost.

When the bearing system is employed in a spindle motor, the bearing bush is mounted as a stationary bearing component in a baseplate in a well-known manner. Should a bearing bush made of plastics according to the invention be used, it is necessary to take account of the relatively high thermal expansion coefficients of plastics compared to those of steel. If the bearing bush were to be connected directly to the baseplate in a conventional way, considerable stress would occur in the area of connection when there are variations in temperature, and this stress would result in a deformation of the bearing bush. This situation is counteracted according to the invention in that an elastic element is disposed at the outside circumference of the bearing bush, by means of which the bearing bush is held in the baseplate or in a sleeve fixed in the baseplate. The elastic element compensates the thermal expansion of the plastic material of the bearing bush. Rubber or similar elastic materials may be used as the elastic material. At the same time, the elastic material has the additional effect of dampening bearing vibrations with the result that they are transferred to the baseplate at a reduced level.

The elastic element is preferably given the form of an elastic coating on the outside circumference of the bearing bush. If the bearing bush is supported in an appropriate sleeve, such as a metal sleeve, the elastic element can then also be made, for example, of punctiform supporting elements that are disposed between the outer surface of the bearing bush and the inner surface of the sleeve.

The above-described embodiment of the invention finds application in bearing systems in which the bearing bush represents the stationary bearing component and the shaft represents the rotating bearing component.

A second embodiment is suitable for a stationary shaft and a bearing bush rotating about the shaft. In this embodiment, the bearing bush rotates together with the hub of the spindle motor about the stationary shaft, wherein both the bearing bush and the hub may be integrally made from a single plastic part. With this embodiment of the invention, there is no need to take any special measures to compensate the thermal expansion of the bearing sleeve or of the hub.

The bearing bush can be manufactured, for example, in an injection-molding process, it being also possible to apply the bearing patterns to the relevant bearing surfaces of the bearing bush in one and the same manufacturing operation. This goes to avoid additional costs for applying bearing patterns to the associated bearing parts, such as the shaft.

### BRIEF DESCRIPTION OF THE DRAWINGS

FIG. 1 shows a first embodiment of the bearing system according to the invention having a stationary bearing bush.

FIG. 2 shows a second embodiment of the bearing system according to the invention having a stationary shaft.

FIG. 3 shows a modified embodiment of the invention vis-à-vis FIG. 2 having a two-piece arrangement of bearing sleeve and hub.

### DESCRIPTION OF PREFERRED EMBODIMENTS OF THE INVENTION

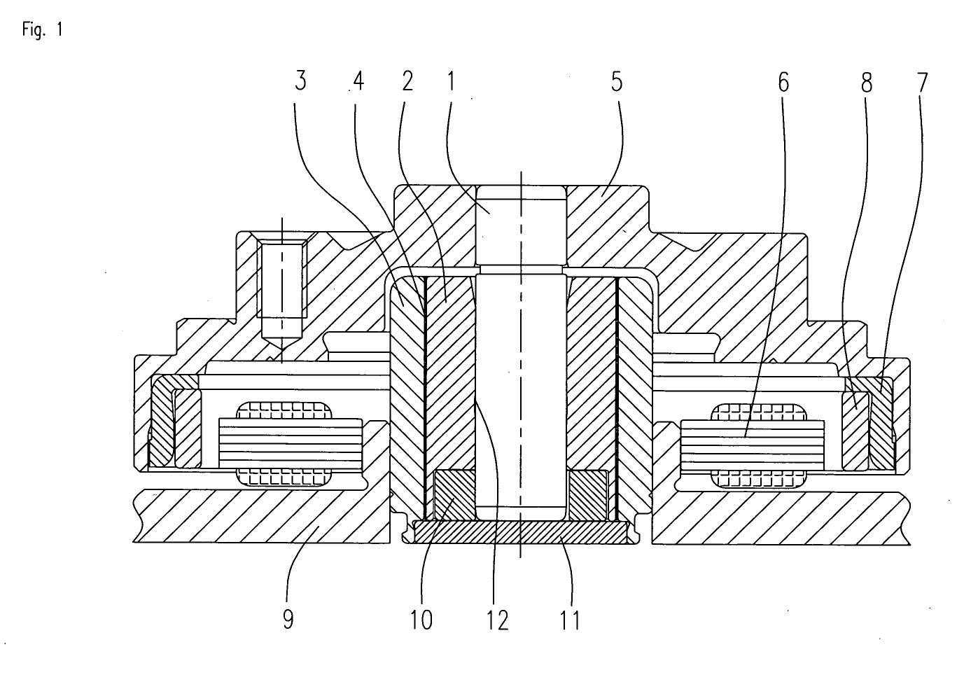

The spindle motor according to FIG. 1, which can be used, for example, for driving a hard disk drive, comprises a bearing bush 2 disposed in a sleeve 3 that, together with the sleeve, is held in a recess in the baseplate 9. The bearing bush 2 has a cylindrical axial bore in which a shaft 1 is rotatably accommodated. The free end of the shaft 1 carries a hub 5 on which one or more storage disks (not illustrated) of the hard disk drive can be disposed and fixed. An annual permanent magnet 8 enclosed by a yoke 7 and having a plurality of pole pairs is disposed at the lower inside edge of the hub 5, an alternating electric field being applied to the pole pairs via a stator arrangement 6 spaced apart from them by means of an air gap, so that the hub 2 together with the shaft 1 is put into rotation. The shaft 1, together with the bearing bush 2 and a thrust plate 10 disposed at one end of the shaft 1, forms a fluid dynamic bearing system having radial bearing and axial bearing surfaces that are separated from each other by a bearing gap 12. The construction and function of this kind of fluid dynamic bearing system is known to a person skilled in the art and shall not be described in more detail here. The bearing arrangement is sealed from below, i.e. in the region of the thrust plate 10, by a cover plate 1.

According to the invention, the bearing bush 2 is made of plastics and can be manufactured at low cost, using, for example, an injection-molding process. In order to compensate the temperature expansion of this kind of plastic body, provision is made for the bearing bush 2 to be enveloped with an elastic element 4, for example, and to be disposed in a sleeve 3 that is mounted in the baseplate 9. Any temperature expansion of the bearing bush 2 is absorbed and compensated by the elastic sheath 4, so that the bearing bush is not subject to any deformation and no stress occurs between the bearing bush 2 and the sleeve 3 or the baseplate 9 respectively. The remaining bearing components such as the shaft 1, the thrust plate 10 and the cover plate 11 can be made in a conventional way out of metal or out of metal alloys; however, they could also be made entirely or partly out of plastics.

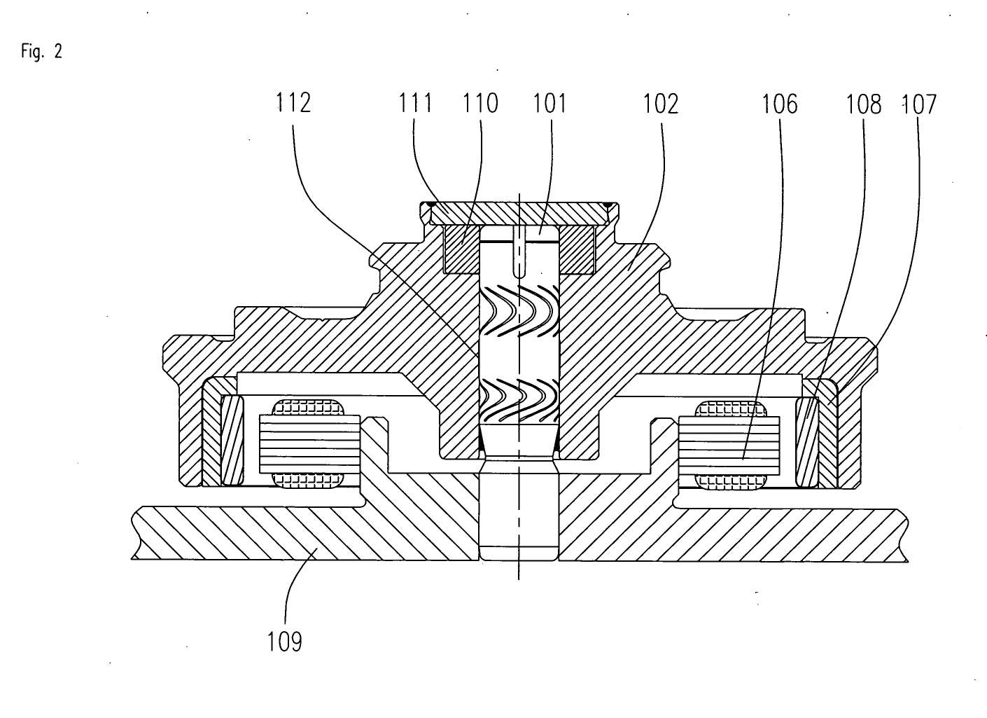

FIG. 2 shows a spindle motor for driving a hard disk drive that has a stationary shaft 101 which is held in a recess in the baseplate 109. The moving part of the bearing system or of the spindle motor is made up of a combination of bearing bush and hub, which is also referred to below as the hub/bearing bush 102. The hub/bearing bush 102 has a concentric bore in which the shaft 101 is accommodated. The hub/bearing bush 102 is rotatably supported on the shaft 101. Several storage disks (not illustrated) of the hard disk drive can be disposed and fixed on the hub/bearing bush 102. An annual permanent magnet 108 enclosed by a yoke 107 and having a plurality of pole pairs is disposed at the lower inside edge of the hub/bearing bush 102, an alternating electric field being applied to the pole pairs via a stator arrangement 106 spaced apart from them by means of an air gap, so that the hub/bearing bush 102 together with the shaft 101 is put into rotation. The shaft 101, together with the hub/bearing bush 102 and a thrust plate 110 disposed at one end of the shaft 101, forms a fluid dynamic bearing system having radial bearing and axial bearing surfaces that are separated from each other by a bearing gap 112. The bearing arrangement is sealed from above, i.e. in the region of the thrust plate 110, by a cover plate 111 that is disposed in a recess in the hub/bearing bush 102.

In this embodiment, the hub/bearing bush 102 according to the invention is made entirely of plastics and can be manufactured cheaply in one production step, such as an injection-molding process. The relatively large temperature expansion of the plastic is non-critical for the hub/bearing bush 102 since its main impact is on the outside circumference of the hub/bearing bush 102 and thus only alters the width of the air gap between the stator arrangement 106 and the magnet 108, which does not prevent either the bearing system or the spindle motor from operating reliably. However, it is necessary to mount the storage disks of the hard disk drive on the hub/bearing bush 102 such that any temperature expansion of the hub/bearing bush 102 does not result in any stress or distortion to the storage disks.

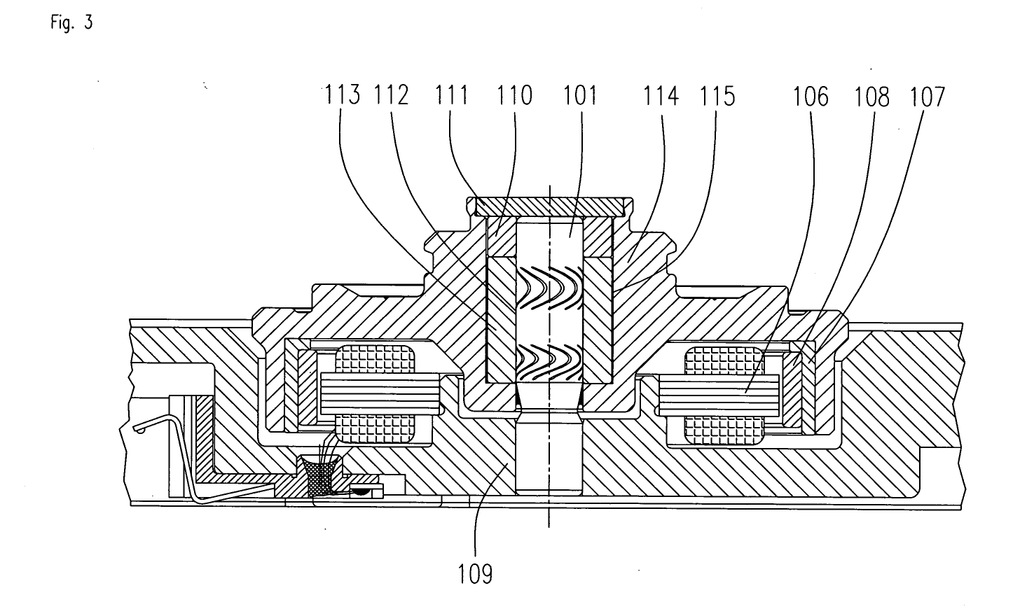

As shown in FIG. 3, the arrangement of hub and bearing bush as shown in FIG. 2 can also be designed in two parts, i.e. the hub 114 and the bearing bush 113 are made up of two separate pieces that are only joined together when the bearing is assembled. The bearing bush 113 according to the invention is made of a plastic, whereas the hub 114 may be made, for example, out of metal or out of plastic as well. In order to compensate the temperature expansion of the plastic of the bearing bush 113, the bearing bush is in turn enveloped in an elastic element 115 and disposed in a concentric bore in the hub 114. Any temperature expansion of the bearing bush 113 is absorbed and compensated by the elastic sheath 115, so that the bearing bush 113 is not subject to any deformation and no stress occurs between the bearing bush 113 and the hub 114.

### IDENTIFICATION REFERENCE LIST

1 Shaft
2 Bearing bush
3 Sleeve
4 Elastic element
5 Hub
6 Stator arrangement
7 Yoke
8 Magnet
9 Baseplate
10 Thrust Plate
11 Cover plate
12 Bearing gap
101 Shaft
102 Hub/bearing bush
106 Stator arrangement
107 Yoke
108 Magnet
109 Baseplate
110 Thrust plate
111 Cover plate
112 Bearing gap
113 Bearing bush
114 Hub
115 Elastic element

1. A fluid dynamic bearing system used particularly for a spindle motor having a shaft (1; 101) that is accommodated in a bearing bush (2; 102) and rotatably supported with respect to the bearing bush,
characterized in that the bearing bush (2; 102) is made of plastics.

2. A fluid dynamic bearing system according to claim 1, characterized in that an elastic element (4) is disposed at outside circumference of the bearing bush (2) by means of which the bearing bush is held in a sleeve (3) or in a baseplate (9) of a spindle motor.

3. A fluid dynamic bearing system according to claim 2, characterized in that the elastic element (4) is given the form of an elastic coating on the bearing bush.

4. A fluid dynamic bearing system according to claim 2, characterized in that the elastic element (4) is given the form of an elastic mounting between the bearing bush (2) and the sleeve (3).

5. A fluid dynamic bearing system according to claim 1, characterized in that the bearing bush (102) is formed as a part of a spindle motor hub made of plastic.

6. A fluid dynamic bearing system according to claim 1, characterized in that an elastic element (115) is disposed at the outside circumference of the bearing bush (113) by means of which the bearing bush is held in a hub (114) of a spindle motors.

7. A fluid dynamic bearing system according to claim 1, characterized in that bearing patterns are formed in a bearing surface of the bearing bush (2; 102).
